(19) United States
(12) Patent Application Publication
(10) Pub. No.: US 2008/0199585 A1
(43) Pub. Date: Aug. 21, 2008

(54) Process for Refining Aqueous Preparations

(75) Inventor: Heinz Laber, Geisenheim (DE)

Correspondence Address: DeMont & Breyer, LLC, 100 Commons Way, Ste. 250, Holmdel, NJ, 07733, US

(73) Assignee: Klaus C. Hartrampf, DE-65193 Wiesbaden (DE)

(21) Appl. No.: 11/813,752

(22) PCT Filed: Jan. 11, 2006
(86) PCT No.: PCT/EP2006/000179

§ 371 Date: Apr. 18, 2008

(30) Foreign Application Priority Data
Jan. 13, 2005 (DE) 10 2005 002 809.8

(51) Int. Cl. C12H 1/12

(52) U.S. Cl. 426/592; 426/431

(57) ABSTRACT

For refining aqueous preparations, in particular alcoholic drinks, the invention provides a process in which comminuted cleaned wood is autoclaved and subsequently components of the wood are extracted, the extraction proceeding with similar extraction media and/or the aqueous preparation to be refined.

The invention relates to a process for refining aqueous preparations, and also to an extract produced in this manner for refining aqueous preparations and use thereof.

In order to give a particular flavour and odour to an aqueous preparation, in particular alcoholic drinks, such as wine or whisky, for example, various processes are already known. For instance, it is usually conventional to give the various drinks improved flavour properties via natural ageing, preferably in oak barrels. Since, however, this means increased time consumption and increased costs associated therewith, for a long time various methods and processes have been developed in order to accelerate natural ageing and simulate the typical flavour and odour which are formed by storage in oak barrels, and thereby to improve the sensory impression of the individual drinks.

The storage of spirits and wines differs depending on the type of drink, properties and legal provisions. For instance, the storage can proceed in various containers such as stainless steel, ceramics, glass or wood, for example. During the storage processes proceed which predominantly have a beneficial effect on the sensory odour and flavour perception. The processes are subdivided during storage in wood vessels such as barrels firstly into extraction processes of components already present, and secondly into migration processes of substances which are only formed during storage as second substances.

In this case it has therefore been found that the components of wood make a critical contribution to the flavour and odour. Wood predominantly consists of organic compounds. These compounds are composed mostly of 50% carbon, 43% oxygen, 6% hydrogen, and about 1% cations. The composition of wood varies depending on the type of tree and type of wood. The abovementioned elements also make up the three main components of wood, that is to say cellulose, wood polyoses and lignin, and also the minor components, what are termed accessory components. Cellulose forms the backbone substance of the unlignified cell wall and consists of a fibril-like macromolecule. The wood polyoses, previously also termed hemicellulose, differ from pure cellulose in that they are more easily hydrolysed. Wood polyoses are polysaccharides which include, inter alia, pentosans, hexosan and amorphous polyoses. The lignin present in wood does not occur as an independent building block, but accompanies cellulose. Lignin is an amorphous macromolecule and consists mostly of 60% carbon, 34% oxygen and 6% hydrogen. This means that high-lignin woods are higher in carbon than low-lignin woods. Lignin cannot be hydrolysed by acids and has a low degree of polymerization. The building blocks of lignin are not arrayed next to one another to form long chains as in cellulose, but are crosslinked to form a three-dimensional molecule. It is not possible to isolate the lignin from the cell wall without attacking the lignin and destroying its original properties. Lignin is stored in the intercellular spaces and acts there as a type of support substance.

Extracts and production thereof which are intended to give features to the alcoholic drinks which are identical or similar to natural storage and ageing are still very laborious and costly in time to obtain and produce.

Attempts have already been made for a long time to develop processes which can shorten or even replace natural ageing and storage.

Already in DE 353735 of 1922, a process is described for improving wines, spirits and similar liquids. Here extraction of oak wood for clarifying wine is proposed. The process described here, however, is very laborious and time-costly.

DE 100 08 759 describes, for example, a process for refining spirits in which during or after bottling of the spirit, wood in any desired shape and type is added to the bottle in order to achieve in this manner improvement in flavour. It is not possible in this process to make exact statements on the flavour of the drink, since this is greatly influenced by how long the bottle is stored and which wood is used.

DD 239 606 likewise describes a process for refining high-grade cereal-based spirits and cereal-based spirits. The process described there is said to reduce the ripening time for cereal-based spirits and generate a typical oak flavour by means of a natural aromatized wood extract. For this wood chips are heated dry at a temperature of 120 to 180° C. for a period of 20 to 150 hours and subsequently extraction is carried out by means of a fine cereal-based distillate at room temperature. The process described there is suitable only for cereal-based spirits and is very time-consuming.

It is an object of the invention, therefore, to provide a process for refining aqueous preparations which is simple to apply, rapid to implement and is particularly inexpensive, and contributes to improvement of the flavour of the aqueous preparations, in particular of alcoholic drinks, and also aqueous preparations produced in this manner.

This object is already achieved in a highly surprising manner by a process according to Claim 1, and also by drinks according to Claims 22 to 25 and an extract according to Claim 26.

Accordingly, the process according to the invention comprises refining aqueous preparations, in particular alcoholic drinks, providing comminuted wood and cleaning the comminuted wood. Subsequently the wood is autoclaved and thereafter follows extraction of components of the wood, in which case the extraction proceeds using similar extraction media such as the aqueous preparation and/or the aqueous preparation to be refined.

The inventors have found out that this process makes it possible to produce an extract which contributes to a significant flavour improvement of an aqueous preparation. It is possible by means of this process to give an aqueous preparation, in particular alcoholic drinks, a sensory impression which corresponds or comes very close to natural ageing and storage in oak barrels. It has also further been found that this process can be carried out using simple means and is therefore inexpensive.

It has been found that it is particularly advantageous when, as comminuted and cleaned wood, use is made of wood shavings and/or wood chips. The wood comminuted in this manner can be particularly easily further processed subsequently, since it is easier to handle. In addition, comminution of the wood means a greater surface area for attack during the subsequent autoclaving.

According to the invention the comminuted wood is cleaned using cold water. Cleaning with cold water ensures that no further unwanted components are leached out of the wood and therefore the accessory components and other components are retained in the wood for the time being.

In an advantageous embodiment, the wood is autoclaved in an autoclave in an oxygen-free atmosphere produced by means of inert gases. In addition, these gases do not react with the components of the wood. This special process makes it possible for components of the wood to be steam cracked during the autoclaving. It enables subsequently better extraction of the components of the wood.

It has in addition been found that it is advantageous when, as inert gases, use is made of nitrogen, argon or helium. These gases ensure that an oxygen-free environment is produced in the autoclave and unwanted oxidation can thereby be prevented. Other noble gases are certainly conceivable in order to be able to produce this state, but these are significantly more expensive.

It has proved to be advantageous when the autoclave is in part filled with an aqueous solution, preferably water, and has a water vapour-saturated environment.

It is particularly advantageous when, during the autoclaving of the wood, a slow homogeneous heating of the wood proceeds at a rate of approximately 2 Kelvin per minute. This ensures that the lignin in the comminuted wood is in part depolymerized and can subsequently dissolve out of the comminuted wood.

It has been found that autoclaving of the wood ideally proceeds at a temperature from 90° C. to 140° C., preferably from 110° C. to 135° C., particularly preferably from 120° C. to 130° C. This temperature ensures gentle heating of the comminuted wood and depolymerization of the lignin.

In addition it is advantageous when the wood, that is to say the comminuted wood, is arranged above the aqueous solution in the autoclave and thus the wood is not brought into contact with the aqueous solution in order to avoid premature extraction of the components and swelling of the wood. In this case the wood can be arranged on a screen, but any other attachment is also conceivable which is suitable for arranging the wood thereon and ensuring a distance from the aqueous solution.

A preferred embodiment of the invention provides that the pressure of the autoclave is preferably set between 1.5 bar and 2 bar, particularly between 1.7 bar and 1.9 bar.

It has been found that the wood is autoclaved for 1 hour to 3 hours, preferably for 1.5 hours to 2.5 hours. This time period is already sufficient to steam crack the comminuted wood sufficiently, that is to depolymerize the components such as lignin, for example, and contributes to time and therefore also costs being saved owing to its low duration.

At the end of the autoclaving, according to a preferred embodiment of the invention, the autoclave is abruptly expanded. This means that the cells of the wood are torn open. In the “bottom phase” of the autoclave, the phenols and tannins land, which are discarded.

In a further development according to the invention, the components are extracted from the autoclaved wood in a suitable device for extraction, preferably a percolator or a trickling column.

In this case the extraction proceeds in such a manner that, for the extraction, similar extraction media are taken such as the aqueous preparation and/or the aqueous preparation to be refined.

The extract obtained can then, metered exactly, be fed to the end product to be refined. This enables the impression of age of the aqueous solution to be exactly controllable, that is to say by the amount of percolate which is added to the aqueous liquid.

As mentioned above, it is advantageous here if, for example, a red wine is to be subsequently refined, to use this same red wine as extraction medium also.

It is advantageous when the extraction temperature is set to a value of <35° C., preferably 20° C. to 30° C. As a result, substances which could be dissolved out of the comminuted wood by heat do not pass into the product to be refined or the extract. Thus percolation proceeds in a virtually cold route.

In a preferred embodiment, the invention provides that during the extraction a substream is removed which is fed directly to the liquid to be refined. As a result, already during the extraction, the aqueous liquid can be refined and no further process step is necessary, which can contribute to reduction in costs.

The invention further provides that the components obtained from the extraction are not added to the aqueous preparations to be refined until subsequently. This makes it possible for the extract first to be obtained and for this only to be added to the liquid to be refined when necessary. It is possible here that, therefore, the extract is obtained first and this is then marketed separately.

This means also that the extract can therefore be fabricated at a separate production site. Since only the extract for refining can be obtained and the aqueous liquid does not need to be refined immediately, this also means that the transport costs are lower.

To obtain an extract which has particularly beneficial properties and is similar or equal to a natural storage, it has proved advantageous when, as comminuted wood, use is preferably made of a hard wood. A hard wood is distinguished by a large fraction of fibres and lignin, and also by a narrow vascular bundle structure. As a result the degree of hardness and the bulk density of the wood increase. Typically, woods having a bulk density of >0.55 g/cm³ are termed hard woods. Woods having a bulk density of <0.55 g/cm³ are termed soft woods.

It is advantageous when, as comminuted wood, use is made of comminuted heart wood. The inner wood of a tree is termed heart wood. It is heavier and harder than the sapwood and occasionally has a different colour.

It is particularly advantageous when the wood used is free from defects, such as, for example, knots, resin galls, cracks, decay and other defects which occur in the wood structure and in the trunk shape, or are produced by environmental influences.

It has been found that, as comminuted wood, preferably use should be made of oak wood, since this contains the typical flavour substances which also transfer into the drinks in the case of natural storage of alcoholic drinks in oak barrels.

It is therefore advantageous when use is made of the wood of a tree which has an age of 70 to 200 years, preferably 80 to 150 years. These trees contain the typical flavour substances in their wood. In addition, in a tree having an age of over 70 years, the heart wood is sufficiently pronounced and the unused sapwood can be used for other uses such as, for example, veneers.

The invention, in addition to the process for refining aqueous preparations, comprises an extract for refining aqueous preparations which can be produced by the above-described process. This extract causes a sensory change in the aqueous solutions to be refined and contributes to a beneficial flavour development.

Also, the invention provides alcoholic drinks and alcohol-free drinks which have been treated with an extract for refining aqueous preparations. In this case the extract can be produced by means of a process as described above.

Addition of the extract gives the alcoholic drinks a flavour and odour note which corresponds to or comes very close to natural storage. By addition of the extract, therefore, in a simple manner expensive storage can be avoided and the production of alcoholic drinks of appealing flavour without long storage is possible.

According to the invention, food supplements are also conceivable which likewise have been refined using an extract which can be produced as described above.

In addition the invention provides the use of an extract which is intended to improve the flavour of an aqueous solution. This extract is obtained by the process described above.

The invention will be described hereinafter more exactly with reference to an example.

### ILLUSTRATIVE EXAMPLE

A 100-year old oak which has a stem free from knots is felled. Subsequently the stem is debarked and the sapwood is separated from the heart wood. This can be achieved by sawing or chipping the wood, but also by peeling the wood.

Subsequently the heart wood is comminuted, so that oak chips are formed.

These oak chips are cleaned with cold water in order to remove any residues or dirt.

The oak chips are then arranged on a screen in a commercially conventional autoclave. The autoclave is filled with water, but only to the extent that the oak chips do not come into contact with water and cannot swell, or become immersed in water.

Subsequently the gas phase of the autoclave is exchanged by introducing nitrogen and the autoclave is closed.

Then there follows the slow heating of the oak chips in the autoclave. For this, in the autoclave, a pressure of approximately 1.8 bar is built up and the temperature slowly increased to 127° C. Subsequently the pressure and temperature are maintained for at least 2 hours.

The autoclave, after the approximately 2 hours, is then, without being cooled in advance, opened abruptly. In this case the cells of the wood are torn open. In the bottom phase of the autoclave, that is to say in the water at the bottom, polyphenols and other tannins collect. However, the lignin depolymerized by the autoclaving is still retained in the oak chips.

Then cold percolation proceeds. The temperature in this case should not exceed 30° C., since otherwise further substances could be dissolved from the wood by the heat, which further substances must not pass into the product.

It must be noted in this case that the oak wood chips are brought into contact with part of the aqueous solution to be refined in a percolator. This process can take some time, depending on the product.

It is also conceivable that a partial product stream is passed continuously via columns over the treated oak wood chips and refining thus takes place.

Depending on which aqueous preparation is to be refined and how strong the change in flavour is to be, the amounts of extract to be added to the aqueous preparation to be refined differ.

### Example 1

For the sensory improvement of Rheingauer Spätburgunder red wine, it is admixed with 0.5% by volume (=V/V %) of the extract which has been obtained by the process described above. A significant improvement of the flavour of the red wine is noticeable. This becomes more intense and leads to a very marked improvement when 1% by volume of the extract is added to the Rheingauer Spätburgunder red wine. The refined red wine differs markedly from the non-refined product and in the Duo test it is always identifiable and is markedly better.

### Example 2

An Italian Montepulciano is admixed with 0.5% by volume (=V/V %) of the extract which has been obtained by the process described above. Owing to the somewhat masking full base tone, the differentiation between the refined product and the unrefined product in the Duo test in longer sampling is somewhat more difficult, however. However, a marked improvement is already noticeable when 1% by volume of the extract is added.

### Example 3

0.1% by volume of the extract is added to a grain-based spirit (38% by volume). Already at this low amount, a marked rounding in taste is noticeable and the product, that is to say the cereal-based spirit, tastes softer and more pleasant.

### Example 4

A Bourbon whisky (1 day old/no storage on wood), very robust, having virtually already a penetrating odour and flavour, is refined with 1% by volume of the extract. Here, storage with a slight vanilla character is noticeable. When 2.5% by volume of the extract are added, a marked storage is recognizable by sensory means, having a completely improved and/or changed odour and flavour profile.

### Example 5

A wine distillate, unstored, approximately 36% by volume, is admixed with 0.5% by volume of the extract. Here, storage may be recognized by sensory means and a rounded flavour forms.

When 1% by volume is added, good improvement of the odour and flavour profile can be recognized by sensory means.

The illustrative examples shown here are only some possible uses of the invention. However, the invention is not intended to be restricted to these examples.

1. A process for refining aqueous preparations comprising:
a) providing comminuted wood;
b) cleaning the comminuted wood;
c) autoclaving the wood; and
d) extracting components from the wood, wherein the extraction proceeds using similar extraction media and/or the aqueous preparation to be refined, characterized in that the wood is autoclaved in an autoclave in an oxygen-free atmosphere by means of inert gas.

2. The process for refining aqueous preparations of claim 1, characterized in that the provision of comminuted and cleaned wood comprises provision of wood shavings and/or wood chips.

3. The process for refining aqueous preparations of claim 1, characterized in that cleaning the comminuted wood comprises cleaning with cold water.

4. The process for refining aqueous preparations of claim 1, characterized in that, as inert gases, use is made of nitrogen, argon or helium.

5. The process for refining aqueous preparations of claim 1, characterized in that the autoclave is in part filled with an aqueous solution.

6. The process for refining aqueous preparations of claim 1, characterized in that by autoclaving the wood a slow heating of the wood proceeds at a rate of 2° Kelvin per minute.

7. The process for refining aqueous preparations of claim 1, characterized in that the autoclaving of the wood proceeds at a temperature from 90° C. to 140° C.

8. The process for refining aqueous preparations of claim 1, characterized in that the wood is arranged above the aqueous solution in such a manner that it is not brought into contact with the aqueous solution.

9. The process for refining aqueous preparations of claim 1, characterized in that the pressure of the autoclave is set between 1.5 bar and 2 bar.

10. The process for refining aqueous preparations of claim 1, characterized in that the wood is autoclaved for 1 hour to 3 hours.

11. The process for refining aqueous preparations of claim 1, characterized in that, at the end of the autoclaving, abrupt expansion of the autoclave proceeds.

12. The process for refining aqueous preparations of claim 1, characterized in that the extraction of components from the autoclaved wood is carried out in a suitable device for extraction, wherein the extraction proceeds using similar extraction media and/or the aqueous preparation to be refined.

13. The process for refining aqueous preparations of claim 1, characterized in that the extraction temperature is set to a value of <35° C.

14. The process for refining aqueous preparations of claim 1, characterized in that, during the extraction, a substream is removed which is fed directly to the liquid to be refined.

15. The process for refining aqueous preparations of claim 1, characterized in that the components obtained in the extraction are added to the aqueous preparations to be refined.

16. The process for refining aqueous preparations of claim 1, characterized in that, as comminuted wood, use is preferably made of comminuted hardwood.

17. The process for refining aqueous preparations of claim 1, characterized in that, as comminuted wood, use is made of comminuted heart wood.

18. The process for refining aqueous preparations of claim 1, characterized in that, as comminuted heart wood, use is made of a heart wood which has a wood structure which is free from defects.

19. The process for refining aqueous preparations of claim 1, characterized in that, as comminuted wood, use is made of oak wood.

20. The process for refining aqueous preparations of claim 1, characterized in that use is made of a wood of a tree which has an age of 70 to 200 years.

21. An extract for refining aqueous preparations produced according to claim 1.

22. An alcoholic drink comprising an extract for refining aqueous preparations according to claim 21.

23. An alcohol-free drink comprising an extract for refining aqueous preparations according to claim 21.

24. A food supplement comprising an extract for refining aqueous preparations according to claim 21.
